(19) United States
(12) Patent Application Publication
(10) Pub. No.: US 2007/0036287 A1
(43) Pub. Date: Feb. 15, 2007

(54) CHARITABLE ONLINE INTERACTIVE SYSTEM

(76) Inventor: Michael Joseph Campbell, Livermore, CA (US)

Correspondence Address: IPSG, P.C., P.O. BOX 700640, SAN JOSE, CA, 95170-0640, US

(21) Appl. No.: 11/419,971

(22) Filed: May 23, 2006

Related U.S. Application Data
(60) Provisional application No. 60/684,907, filed on May 25, 2005.

(51) Int. Cl. H04M 1/64

(52) U.S. Cl. 379/67.1

(57) ABSTRACT

A method for facilitating a charitable guest reservable online celebrity interaction (CGROCI) between a guest and a celebrity via a network is disclosed. The method includes providing guest with information about the charitable nature of the CGROCI. The charitable nature relates to a financial benefit provided to a charity as a result of conducting the CGROCI. The method also includes receiving via the network reservation data, which includes at least a time to conduct the CGROC, from the guest. The method further includes providing an online interactive environment to conduct the CGROCI between guest and celebrity, whereby the celebrity is geographically remote from the guest but interacting with the guest via the online interactive environment. The method yet also includes processing payment from the guest, whereby at least a portion is provided to the charity and another portion is provided to the celebrity.

### RELATED APPLICATIONS

This application claims priority under 35 U.S.C. §119(e) of the co-pending U.S. provisional application Ser. No. 60/684,907 filed by the same inventor on May 25, 2005 and entitled “Charitable Online Interactive System.”

### BACKGROUND OF THE INVENTION

People, in general, are fascinated with celebrities. As the term is employed herein, a celebrity may be fictional and/or non-fictional. For example, non-fictional celebrities may include, but are not limited to, actors, singers, writers, athletes, models, politicians, experts in their fields of endeavor, business leaders, and the like. Fictional celebrities may include, but are not limited to, cartoon characters and/or other fictional characters, for example.

Fans tend to be fascinated with celebrities, and often harbor a desire to interact with their favorite celebrities. Likewise, celebrities are often motivated to maintain a strong relationship with their fans. Interactions with fans tend to strengthen the celebrity's fan base, and a strong fan base often helps provide a celebrity with continuing success.

For example, a strong fan base often helps increase the size of the viewing audience for a particular television show, which in turn increases the revenue the show can charge for advertising and/or syndication. The increased revenue often translates into increased longevity for the show and/or increased salary for the celebrity. As another example, fans tend to be eager consumers of products that their favorite celebrity promotes. Accordingly, a strong and loyal fan base often translates into increased sales for products involving the celebrity, often leading to increased product endorsement income for the celebrity.

Paid individual interactions with fans represent, to some celebrities, an untapped revenue source. While this is true for currently famous celebrities who can command the highest price for their appearances, this is also true and perhaps more important for celebrities who are retired from the trade for which they originally gained fame. For example, many ex-actors or retired athletes often find themselves working in less lucrative fields after their careers in the public eye have ended. These celebrities, who now find themselves working for less pay, often wish to augment their current income with activities that capitalize on their past fame and/or exploits. Since paid public appearances are often not available to these “former” celebrities, paid individual interactions would have been an ideal way for these celebrities to both keep in touch with their fans and increase their current income. On the demand side, many fans fervently wish to have the opportunity to individually interact with their favorite celebrities, and are willing to pay handsomely for such individual interactions.

However, few opportunities are readily available currently for fans and celebrities to individually interact. The opportunities that are currently available are usually impersonal and unsatisfying for both the celebrities and their fans. For example, fans may attend a movie premier in hope of catching a glimpse of their favorite actor in the audience and perhaps of shaking the actor's hand (if the actor's security permits). As another example, fans may stand in line for a long period of time at a book signing in hope of spending a few seconds with their favorite author while obtaining her autograph on her latest book.

Sometimes, fans are given the opportunity to compete among themselves (e.g., sweepstakes or auctions) for a chance to meet a celebrity in person. For example, a radio station may, in an effort to increase its listener base, give fans an opportunity to compete in order to win the opportunity to meet a particular singer and perhaps have pictures taken with that singer. As another example, a website such as MSN.com may give its users a chance to compete to electronically chat with one of five celebrities by filling out a questionnaire. However, these opportunities are few and, even when they are available, the chance for any given fan to win the contest and to actually meet with the celebrity is both slim and completely out of the fan's control.

Personal individual interactions between celebrities and fans have been rare for a variety of reasons. For example, since celebrities tend to be highly visible public figures at some point in time, stalking incidents threatening the celebrities' privacy, physical well-being, and/or image are typically of great concern to the celebrities and/or the entities organizing such individual personal interactions. Many actors and authors, such as Jane Fonda or Salmon Rushdie, expressing their viewpoints on a controversial topic have been targets of death threats. A face-to-face interaction with a crazed fan can quickly turn disastrous if the security arrangement is flawed.

Perhaps as a result, a face-to-face meeting between a celebrity and her fan(s) often involves elaborate security precautions, which are both time-consuming and expensive to arrange. Other costs are also often involved in such a face-to-face meeting, including for example the expenses involved in traveling to-and-from the meeting site. Since the celebrity may not live in the same town, such a meeting may be possible only if the celebrity happens to be in town or, more rarely, is willing to travel to meet.

Since the physical meeting arrangements that enable a face-to-face meeting between a celebrity and her fan(s) may be time-consuming and/or expensive to implement, many celebrities have not found it economical and/or convenient to arrange for more frequent personal individual interactions with their fans. For A-list celebrities, i.e., those who are highly visible and/or well-known and can thus command a high price for their personal appearances, the physical meeting arrangement costs may be deemed part of the cost of doing business for the celebrities and/or the entity that organizes the face-to-face interaction. For other celebrities, such as retired athletes or ex-actors who are no longer well-known and are thus less able to command a high price for their appearances, such physical meeting arrangement costs may render the face-to-face meetings impractical from an economic standpoint.

Although it is possible that costs for arranging the personal individual interaction with a celebrity may be borne by the willing fan himself, many celebrities are sensitive to the perception that they are eager to “sell” their presence to anyone willing to pay. Celebrities are rightfully concerned since such an image-tarnishing perception may diminish the aura of mystique and/or inaccessibility that often allow a celebrity to continue to command admiration and adoration from her fans. Such a perception may also degrade the carefully-crafted image that the celebrity has been providing the public. For example, an actress well-known for her romantic roles may not wish to be known as someone who is willing to spend an hour speaking with any fan who is willing to pay her asking price for a personal face-to-face meeting.

It should be pointed out that this concern with image exists even if the meeting is strictly over an electronic medium, i.e., without involving the physical danger and/or expenses associated with a physical face-to-face meeting. Even if the interaction is purely electronic, celebrities tend to be unwilling to participate in activities that may “cheapen” their image, particularly since a celebrity's image is often the source of her income and power. As discussed, the perception that a celebrity is too eager to sell to any willing bidder her personal time for personal financial gain is one such image-tarnishing perception.

Note that while the above issues have been discussed in connection with reference to non-fictional celebrities, the same issues exist to a certain extent with fictional celebrities. Companies that own the copyrights to the fictional characters may rightfully be concerned with the public perception of the fictional characters. For example, the perception of Superman™ willing to talk to anyone for an hourly fee may not necessarily be the image that the copyright owner of Superman™ wishes to promote their copyrighted character.

A physical meeting between a fictional celebrity (such as Spiderman™) and his admirer also involves the same travel and lodging expense issues for the person playing the role of the fictional character. Deranged fans may do bodily injury to the personal dressed in the fictional character outfit as easily as they harm a non-fictional celebrity. Similarly, an out-of-control fan may behave in ways that are degrading to the image of the fictional celebrity. As in the case with fictional celebrities, many of the concerns exist even if the meeting between a fictional celebrity and his fan is purely electronic.

For these reasons, many celebrities and/or their companies are reluctant to pursue paid personal individual interactions with fans as a possible revenue source.

### SUMMARY OF INVENTION

The invention relates, in an embodiment, to a computer-implemented method for facilitating a charitable guest reservable online celebrity interaction (CGROCI) between a guest and a celebrity via a computer-network. The method includes providing the guest with information informing the guest of a charitable nature of the CGROCI. The charitable nature relates to a financial benefit provided to a charity as a result of conducting the CGROCI. The method also includes receiving via the computer-network reservation data from the guest. The reservation data specifies at least a time to conduct the CGROCI. The method further includes providing an online interactive environment to conduct the CGROCI between the guest and the celebrity, whereby the celebrity is geographically remote from the guest but interacting with the guest via the online interactive environment. The method yet also includes processing payment from the guest for the CGROCI, whereby at least a first portion of the payment is provided to the charity and a second portion of the payment is provided to the celebrity.

In another embodiment, the invention relates to a system for facilitating a charitable guest reservable online celebrity interaction (CGROCI) between a guest and a celebrity via a computer-network, wherein providing the guest with information informing the guest of a charitable nature of the CGROCI. The charitable nature relates to a financial benefit provided to a charity as a result of conducting the CGROCI. The system includes a mean for receiving via the computer-network reservation data from the guest. The reservation data specifies at least a time to conduct the CGROCI. The system also includes a mean for providing an online interactive environment to conduct the CGROCI between the guest and the celebrity, whereby the celebrity is geographically remote from the guest but interacting with the guest via the online interactive environment. The system further includes a mean for processing payment from the guest for the CGROCI, whereby at least a first portion of the payment is provided to the charity and a second portion of the payment is provided to the celebrity.

In yet another embodiment, the invention relates to a computer-implemented method for facilitating a charitable guest reservable online celebrity interaction (CGROCI) among a plurality of simultaneous instantiations of a celebrity by plurality of human actors and at least a first guest and a second guest via a computer-network. The celebrity represents a fictional character by human. The method includes providing the first guest and the second guest with information informing the first guest and the second guest of a charitable nature of the CGROCI. The charitable nature relating to a financial benefit provided to a charity as a result of conducting the CGROCI. The method also includes receiving via the computer-network reservation data from the first guest and the second guest, the reservation data specifying at least time appointments to conduct the CGROCI. The method further includes providing an online interactive environment to conduct the CGROCI among the first guest and the second guest and the plurality of simultaneous instantiations, whereby the plurality of human actors are geographically remote from the first guest and the second guest but interacting with the first guest and the second guest via the online interactive environment. The method yet also includes processing payment from the first guest and the second guest for the CGROCI, whereby at least a first portion of the payment is provided to the charity and a second portion of the payment is provided to an owner of a right to the celebrity.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A shows, in an embodiment, a table listing various features provided by the software that enable CGROCIs via the internet.

FIG. 1B shows, in an embodiment, a simple diagram of a sample screen of an interactive session.

FIG. 2A shows, in an embodiment, a simplified flowchart illustrating a sample reservation portion of the computer-implemented process.

FIG. 2B shows, in an embodiment, a simple diagram of an example of a screen that the guest may see upon accessing the website.

FIG. 2C shows, in an embodiment, a simple diagram of an example of a screen providing data about the celebrity.

FIG. 2D shows, in an embodiment, a simple diagram of an example of a reservation screen

FIG. 3 shows, in an embodiment, a simplified flow chart of a login process from a guest perspective.

FIG. 4 shows, in an embodiment, a simplified flow chart of the log-on process from the system perspective.

FIG. 5 shows, in an embodiment, a simplified flow chart of the post session process.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that include a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

In accordance with embodiments of the present invention, there are provided methods for enabling celebrities to conduct charitable guest-reservable online celebrity interactions (CGROCIs) in a manner that generates income while substantially obviating the risk of developing the aforementioned image-tarnishing reputation for the celebrity. Embodiments of the invention provide methods and apparatus to enable a celebrity and her fan to reserve and subsequently conduct the interactions online based on the premise that at least a portion of the proceeds of the CGROCIs be allocated for charitable purposes.

In an embodiment, it is sufficient that the public and the user be presented with the knowledge that some portion of the proceeds of a CGROCIs will be allocated to charity. In such an embodiment, information pertaining to the exact non-zero portion that is actually allocated to charity is not provided to the user by the embodiment. Instead, such an embodiment leaves it to the celebrity to privately specify the exact non-zero portion that is allocated to charity. Since every CGROCIs benefits charity to some degree, embodiments of the invention enable a celebrity to generate at least some revenue from the online personal interaction under a reputation-enhancing cover. Since at least a non-zero portion of the revenue generated from such a CGROCIs benefits charity, embodiments of the invention also provide for efficient methods and apparatus for charities to receive some portion of the proceeds.

It should be noted at this point that the term “guest” herein describes the entity that wishes to have a personal interactive video session with a celebrity via a computer network and encompass a single natural person or a group of natural persons. The term “celebrity” herein may refer to a single non-fictional celebrity or a single fictional character or even a group of fictional characters. A fictional character may be as simple as a human in an appropriate costume portraying the fictional character. The costume, mask, and/or voice of the fictional character may be electronically enhanced and/or animated (either in real time or as part of the video transmission process). As the term is employed herein, charitable denotes that at least a portion of the proceeds is allocated for charitable purposes, and there is no requirement that the entire proceeds be allocated to charity.

Further, embodiments of the invention enable a guest to reserve, using the online tool provided, an interactive session with the celebrity at a time that is convenient for the guest and the celebrity. For example, embodiments of the invention may present a guest, on a website, with a plurality of celebrities to choose from, as well as the time slots during which individual celebrities have specified to be available for conducting CGROCIs. As mentioned, the celebrities may be either fictional (e.g., Bugs Bunny™ ) or non-fictional (e.g., Tom Hanks). Other information about the celebrities (including for example his biography, his accomplishments, the cost for the CGROCIs for that celebrity, and the like) may, in an embodiment, be furnished by the website to assist the guest in his decision-making process.

Embodiments of the invention permit the guest to choose among the available time slots or to propose a different time slot, which may be subject to agreement by the celebrity. Generally speaking, the reservation by a guest is subject to approval by the celebrity and/or the company operating such a website. For example, a request for a CGROCIs by a known stalker may be refused by the celebrity and/or the website operator. In an embodiment of the invention, the guest may need to register before a reservation or an interactive session may begin. In the registration process, the guest may be requested to create a user account and provide personal data, payment details, and electronically sign a user agreement.

The reservation process may require the guest to electronically sign a code of conduct. In an embodiment, a given celebrity may have an option to include languages in the code of conduct that may be unique to that celebrity. During the interactive session, a website host and/or celebrity may, in an embodiment, terminate an interactive session if the guest fails to abide by the user agreement and/or code of conduct. Embodiments of the invention include apparatus and methods for facilitating the termination process and any settlement that may be required afterward.

As part of the reservation process, the guest may, in an embodiment, be offered an opportunity to provide personal details that may enable the website host and/or celebrity to customize the interactive session to provide a more personalized experience to the guest. Customizing the interactive session may include, but are not limited to, preparing dialogues that may be of interest to the guest, creating a skit that a fictional celebrity may perform, and displaying merchandise items that may appeal to the guest.

Payments may be made by the guest as part of the reservation process. During the payment process, the guest may be provided with an opportunity, in an embodiment, to select one or more charities that the guest may wish to support with at least a portion of the proceeds from the CGROCI. The list of charities that a guest may choose from may include charities that the celebrity supports.

In an embodiment, the session between the celebrity and guest may be recorded. The recorded session may be offered to the guest, either as a free gift or as an item for purchase. With the recorded session, the website host is able to maintain a history of the sessions that have taken place. The recorded sessions also provide the website host with evidence to support any possible lawsuit or investigation.

Embodiments of the invention also provide guest-selectable product displays during the CGROCI. Generally speaking, these products may pertain to the celebrity and/or the role(s) played by the celebrity at one point in time. These products may be selected and purchased by the guest if desired. In an embodiment, the products may be positioned along the border of the screen window through which the interaction occurs. In another embodiment, the products may be integrated into the background of the interactive scene (e.g., a toy car set as part of a scene for Spiderman™). By clicking or otherwise selecting the product displayed during the CGROCI, the guest may indicate that he wishes to purchase such product. The selected products may be purchased during the session or may be queued for purchase at the end of the session.

Toward the completion of the interactive session, the guest and/or celebrity may, in an embodiment, be provided with an online tool to comment and/or give feedbacks about the interactive session and the parties involved. These comments/feedbacks may, for example, be employed in an embodiment to assist other guests in selecting a particular person who plays a fictional character. If the interactive session is terminated early, the website host may be able to provide comments about the reason(s) for the early termination (such as technical difficulties or the failure of a guest to abide by the terms of the agreement).

In an embodiment of the invention, a database is implemented. The database allows a guest to perform complex searches on available celebrities and their time slots. Also, the database may store information about the guest such as personal demographics, merchandise items purchased, and interactive sessions that have been completed or are still pending. Further, the database may store information about the interactive session (e.g., comments from the guests, the celebrities, and the website host). The database may also store statistical information that the website host may be able to use for improving the overall experience for future guests.

In an embodiment, the database facilitates the scaling of appearances by a fictional character. For example, many people may successfully play the role of Snow White™, a fictional character. These people and/or their companies may wish to derive some revenue from CGROCI. Thus, the database may have up to dozens or may be even hundreds of Snow White™, their location (e.g., city and state), and available time slots. These time slots reflect, in an embodiment, the time slots that the people playing these Snow White™ roles have indicated to be time available for CGROCIs. At any given time, a plurality of the fictional Snow White™ characters may be reserved and/or engaged in interactions with respective guests. As can be seen, embodiments of the invention support substantially unlimited scaling in the number of fictional characters that can be reserved and/or interacted with by the general public to support revenue generation for the copyright holder and/or the charities involved.

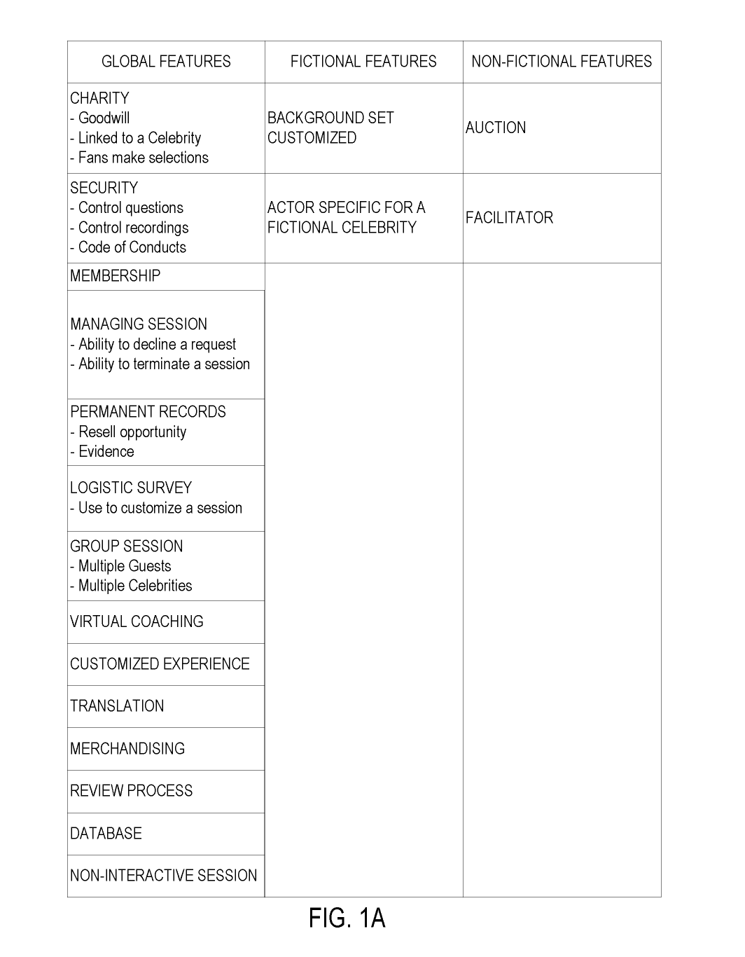

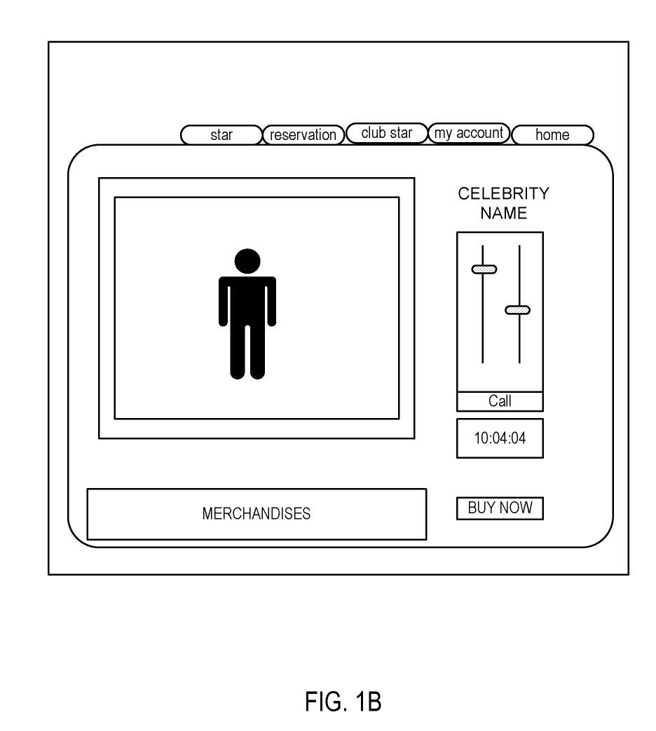

The features and advantages of the invention may be better understood with reference to the figures and discussions that follow. FIG. 1A shows, in an embodiment, a table listing various features provided by the software that enable CGROCIs via the internet. In an embodiment, the CGROCIs may be offered via the internet using browsers that support interactive video chats and/or other network-based video conferencing technology. The features may be thought of as pertaining to non-fictional characters (“non-fictional features”), fictional characters (“fictional features”) or both (“global features).

With respect to global features, the computer-implemented method supports charity-giving CGROCIs that enable revenue generation while enhancing the celebrity's standing and/or image as a charitable person. A celebrity may specify that at least a non-zero portion of the CGROCIs proceeds be allocated to one or a plurality of charities with which she is associated. The remainder of the proceeds may be split as appropriate between the celebrity and the owner of the website that hosts the CGROCIs.

On the website and specially during reservation and interaction times, the general public and the guest may be made aware, by visual and/or textual representations for example, of the association between the CGROCIs and charitable giving, as well as of the association between a specific celebrity and one or more charitable causes. Thus, the taint associated with exchanging a celebrity's time for personal individual interaction is substantially alleviated, enabling more celebrities to participate in CGROCIs without risking their public image. Such charity-giving feature of the session also increases the desirability of the interaction for the guest as he can feel the sense of satisfaction from knowing that at least a portion of the money paid goes to support a charitable cause. For both the guest and the celebrities, the fact that the CGROCIs involves giving to charity substantially removes the self-serving taint from the paid celebrity interaction.

To further reinforce the connection between charity giving and the CGROCIs, embodiments of the invention further provide for a selection tool that enables the guest to indicate during the reservation phase and/or the interaction phase the specific charity to which he wishes to donate the aforementioned non-zero charity donation. Although the exact amount to be donated may be decided privately by the celebrity, the fact that the guest is allowed to participate in the selection further emphasizes the charity-giving nature of the CGROCIs, increases satisfaction for the guest, and further removes the self-serving taint from such interaction.

Since the CGROCIs is implemented as a computer-implemented apparatus and/or method, expenses and time-consuming arrangements associated with face-to-face meetings are substantially eliminated. Further, the threat of physical violence to the celebrity is simply obviated. These aspects increase the desirability of the interaction to both the guests and the celebrities.

Embodiments of the invention include reservation facilities to enable a potential guest to use the computer-implemented tool to search for a celebrity based on various search criteria. Extensive informational pages/frames and help pages/frames may be provided to assist the guest with website navigation and/or with information about celebrities. Celebrities themselves may employ a user interface to enter information and/or to indicate available times. Once the available times are published on the website, potential guests may select among the time slots that the celebrity has indicated to be available for CGROCIs. Such reservation may be deemed provisional by the system until accepted and/or rejected by the website host and/or the celebrity herself.

In an embodiment, a celebrity and/or the website host may employ an information screen to specify in advance the topics that a celebrity may wish to avoid. For example, a particular actress may wish to decline to discuss or even entertain questions pertaining to her pending divorce. As another example, highly personal questions that may render a celebrity susceptible to identity theft may be specified by the website operator to be questions that are not appropriate during CGROCIs.

As such, at least the topics/questions considered to be potentially embarrassing to the celebrity may be excluded from the interaction. If a guest violates the exclusion guidelines specified by the celebrity and/or the website (which guidelines may be part of the contract entered into by the guest as a condition for participation), the interaction session may be terminated immediately, in an embodiment, by either the celebrity or the operator of the website for cause.

Further, the celebrities and/or the website may specify guidelines pertaining to whether the guest is permitted to make a recording (digitally or otherwise) of the interaction session and whether the guest is permitted to distribute any recordings made. These guidelines may include those that cover all celebrities as well as guidelines that may apply to specific celebrities. Again, these guidelines may be made part of the contract that the guest is required to agree to as a condition for participation. Additionally or alternatively, the video and/or audio feeds of the session may be altered to render recordings less attractive or easily tracked (e.g., via watermarking) should a guest decide to secretly record the session in violation of the guideline. In an embodiment, the guidelines may permit recording for an additional fee, or may present the guest with a choice to purchase the recording after the session is completed.

Registration is another global feature implemented to control access to the website. Registration refers to the process of registering a guest as a member with the website before allowing the guest to reserve and/or participate in a CGROCI. Registration may require the guest to create a user account by providing personal demographic data. Further, the registration process may require the guest to provide a valid form of payment for CGROCIs. For example, the guest's credit card information may be obtained and the credit card may be charged in advance of any CGROCIs to eliminate collection risks for the website operator and/or the participating celebrity.

Another global feature of an embodiment of the invention is the provision of a software-based tool that enables the website operator and/or the celebrities to manage the interactive session. Managing the interactive session may involve declining or accepting a reservation request made by a guest through the website. For example, a guest may have completed a reservation to have an interactive session with celebrity A at a particular time. However, celebrity A may decline the request because celebrity A may have a conflict at the requested time. In another example, the website host may refuse a request from a fan because the website host may have identified the guest as a potential troublemaker.

Another way to manage an interactive session may involve using a software-based tool to terminate the CGROCIs early. The reasons a celebrity or a website host may terminate a CGROCIs may include, but are not limited to, a violation of the contract that the guest entered into prior to being allowed to participate. For example, guidelines in the contract may prohibit the utterance of offensive remarks or may prohibit certain conduct or may specify the topics that are off-limits. If a guest violates the contract, early termination may result. In general, if the session is terminated for cause based on unacceptable behavior by the guest, the guest may not be entitled to a refund of any portion of the paid amount for the CGROCIs.

Control of guests may also be enhanced by keeping a permanent record of the CGROCIs. The recordings may be deemed the exclusive rights of the website and/or the celebrity and may be offered for sale to the participating guest and/or any other interested entities. A permanent recording of the interactive session also provides tangible evidence that may be used later to support any lawsuits that may arise. Further, the permanent recordings may be made available to government agencies that may require supporting evidence in a criminal investigation. In an embodiment, the website informs the guest of the recording and/or its ramifications. Such information, when disseminated to guests, tends to act as deterrence against abusive behaviors by guests.

A logistic survey is a global feature that allows an interactive session to be personalized to an individual guest. As part of the reservation process, the guest is requested to complete a logistic survey. The logistic survey provides a vehicle for the guest to provide information that may help the website host and/or the celebrity in personalizing the upcoming interactive session. The logistic survey may include, but is not limited to, describing the reason for the interactive session (e.g., the occasion involved), providing personal information about the guest, and indicating the number of participants that may be participating in the interactive session. In an embodiment, the logistic survey may be completed by a third party for the benefit of the guest, such as by a parent for a child or by a secretary for an executive. The ability to allow a third party to specify such logistic survey information enables the celebrity to surprise the guest with personalized facts during the CGROCI, often to the delight of the guest.

Group session is a global feature that may be implemented in some embodiments. Group session may occur if a group of guests wish to share a single session with a celebrity, due to cost or other reasons. The guests may share a single computer and video camera or may share using different computers and different video cameras. In the latter case, the website may provide multiple panes in the display screen to enable all guests and the celebrity to simultaneously participate.

Group session may also occur if the guest may want an interactive session with a group of celebrities instead of one celebrity. For example, a child may wish to interact with all seven dwarves during a given CGROCI.

Another global feature of the interactive session is the ability to offer, in an embodiment, virtual coaching. Through the video interaction, the celebrity may review the guest's performance, for example, and provide critique or suggestions. For example, a well-known celebrity singer may listen to performance by a guest and provide suggestions regarding vocalization or timing. Likewise, a politician may listen or view a speech by a guest and provide critique and/or suggestions. The website provides the ability for the celebrity and the guest to collaborate for a fee, a portion of which is allocated to charity.

Experience customization may represent another global feature implemented, in an embodiment. A customized experience refers to an interactive session in which the celebrity and the environment around the celebrity (e.g., background set) may be tailored to offer the guest a more immersive experience. For example, an actor that is famous for his role in a particular movie may conduct the interactive session in front of a blank screen. An image from the movie may be projected onto the blank screen to give the impression to the guest that the celebrity is back in his famous role during the session. Alternatively and/or additionally, elements on the display screen such as control icons, text, graphics, etc., may be customized to enhance the session experience for the guest. See FIG. 1B for a sample screen of an interactive session. The screen in FIG. 1B and other figures herein have been simplified for ease of illustration; however, during an actual session actual image of the celebrity, contents about the celebrity and the guest, and interactive graphics may be utilized.

Translation is another global feature that may be implemented. Since the interactive session is an online experience, the guests and celebrities may be from different parts of the world. In some instances, guests and celebrities may not be able to comfortably communicate in the same language. To facilitate the interactive session, a translator may be available to assist both parties. In an embodiment, the translation is performed by a third person who has access at least to the audio portion of the interaction and who provides the translation during the session to the guest and/or the celebrity. Translation leverages on the transnational feature of the internet and opens the market for CGROCIs to foreign guests.

Merchandising is another global feature that may be implemented in embodiments of the invention. In the interactive session, a fan may be able to purchase products that are associated with or promoted by his favorite celebrity. For example, books may be available for purchase at a special price during an interactive session with a favorite author. This information may be made available to the guest using a special area of the screen. For example, banner spaces promoting theme merchandising may be available for the guest to click on to purchase.

Further, guests may be able to purchase items that may be displayed as part of the session's background, especially if the background set has been customized. For example, a guest may want to purchase the tapestry that is part of the session's electronic background. For a fictional character, the electronically generated background may include items such as toys, costumes, gadgets, etc. that the guest may be able to click and add to the purchase order. In an embodiment, the electronically generated background along with the clickable merchandise item changes as the storyline progresses. For example, the fictional character Snow White™ may be shown in different electronically generated backgrounds during a session as the story progresses. The clickable merchandise items integrated into these backgrounds may change from scene to scene, presenting the child guest with the opportunity to purchase different items at different times. As another example, different songs may be performed at different times during the session, and icons representing those songs may be presented during the songs' performance to allow the guest the opportunity to download a particular song at a particular time. The selected merchandise item may be placed in an electronic shopping cart for settlement at the end of the interactive session. The actual fulfillment of the order may be performed by the website operator or may be accomplished through affiliation with other e-merchants.

A review process is another global feature that may be implemented in an embodiment. At the end of the interactive session, both celebrities and guest, in an embodiment, may have the opportunity to provide comments about the interactive session. For example, the fans and celebrities may be able to express their opinions on how successful they thought the session was. Feedback may be used by the website host to determine the appeal of a celebrity and may also be used to rate a particular guest to determine whether that guest should be allowed to participate in a future session if that guest makes a reservation request in the future. In the case of fictional characters, such feedback may be employed to pair a particular person who plays the fictional character with a particular guest in a future session.

Since the personal interaction is computer-based and guest-reservable, embodiments of the invention employ one or more databases that may be accessed by the celebrities, the guests, and/or the website operator to store searchable bibliographical information pertaining to celebrities, to facilitate scheduling of reservation requests, to settle the financial aspect of the sessions, and/or to facilitate authentication of celebrities and guests. In an embodiment, a guest may be furnished with a software-based requesting tool to enable the guest to propose a time for an interactive session with a specific celebrity, which time and/or celebrity may not be listed as available in the database. The website operator may employ the information accompanying the request to attempt to fulfill the request by forwarding the request to the celebrity for possible consideration.

The database may also include the names of black-listed guests who are not allowed to interact with a specific celebrity or with any celebrity. For example, a given celebrity may furnish the name of her stalker and that stalker would be black-listed from being able to reserve a CGROCIs with that celebrity. Moreover, the database may include the identity of guests whose user contracts have been violated in the past due to, for example, guest misconduct. In less severe cases, a violation may result in the guest being placed in a special category, requiring the guest to employ the service of a third party moderator in a future CGROCIs to ensure that the violation would not be repeated. In more severe cases, a violation may result in the guest being black-listed and/or banned and may even lead to civil and criminal prosecution.

A non-interactive session is another global feature that may be implemented in an embodiment. In an example, with a non-interactive session, a guest may request a celebrity to record a personalized video greeting for a recipient. The process of requesting a non-interactive session may be similar to the process of requesting an interactive session. In an embodiment, a guest may employ a reservation facility to register and search for available celebrities. To personalize the non-interactive session, the guest may be requested to respond to a logistic survey about the recipient, in an embodiment. In an embodiment, the guest may be requested to provide information about methods (e.g., electronic method such as emails, by mail, etc.) for sending the recorded non-interactive session.

Consider the situation wherein, for example, a recipient receives an email with an embedded link. By clicking on the link, the recipient may view the non-interactive session, such as a personalized video greeting. In an embodiment, the recipient may view the non-interactive session a plurality of time for a limited period. In an embodiment, merchandises may be incorporated into the non-interactive session.

Beside the global features listed above, there are some features that may be implemented for interactive session with non-fictional celebrities. For example, a non-fictional celebrity may be in such high demand and/or her available time slots so limited that an auction may be employed to determine which guest would be able to interact with that celebrity. Due to the charity feature, such an auction may no longer be viewed as self-centered by the celebrity. Instead, such auctions may simply be accepted as a conventional approach to increase the charity proceeds, thereby removing the taint of greed and any possible image detraction from the auction process. An auction may be conducted electronically, thereby enabling the session price to be increased without incurring a substantial amount of cost for conducting the auction itself.

In an embodiment, corporate sponsorships may drive auctions with celebrities. For example, a given corporate sponsor may wish to generate goodwill by auctioning off a personal interaction session with a particular athlete celebrity. Unlike an auction for goods, however, embodiments of the invention may specify to the group of bidders that the website operator and/or the celebrity reserves the right to determine the winner based on factors that are additional or alternative to simply the highest bidding amount. Such factors may include, for example, whether the highest bidder is a known stalker (in which case the stalker would not be scheduled for a session) and other preferences by the celebrity.

In an embodiment, a facilitator may be provided in the electronic interaction. A facilitator may represent a third-party that is available to help mediate the interactive session between a celebrity and a guest. In an embodiment, the facilitator may work on behalf of the website operator and may be physically located in a location different from either the guest or the celebrity. Embodiments of the invention allow the facilitator to participate electronically. For example, some guests and/or celebrities may feel more comfortable in a panel setting where there is a facilitator to fill in during uncomfortable silent periods or to guide the discussion along comfortable topics. If either the guest or the celebrity appears to misbehave or about to misbehave, the facilitator may be able to intercede and head off a potentially embarrassing situation.

Generally speaking, fictional celebrities do not have the same time constraints as non-fictional celebrities. For example, Mickey Mouse™, a favorite cartoon character with the younger generation, may be played by a plurality of actors. Thus, interactive sessions with Mickey Mouse™ are not limited to a time schedule of one person. Instead, the time available to interact with Mickey Mouse™ may be limited only by the number of actors available to play the role of Mickey Mouse™. Since the interaction facilitated by embodiments of the present invention is electronically conducted, the scalability with respect to revenue generation from interaction with fictional celebrities is essentially unlimited. If the demand exists, hundreds or thousands of interactions may take place simultaneously. For example, hundreds of Snow White™ may be participating simultaneously in hundreds of birthday parties with guests around the globe. Additional bandwidth and processing demands required to accommodate such simultaneous interactions may be accommodated by known computing and/or networking approaches, including for example adding servers and/or performing load balancing.

As mentioned, even though the fictional character may be played by a plurality of actors, a specific actor playing a given fictional celebrity may be requested by a guest. For example, the aforementioned database may store information pertaining to various actors who may be available to play a particular fictional celebrity. If a guest had a particularly satisfactory session with a given actor in the past, such information may be stored in the database to automatically or upon request by the guest pair that actor with that guest.

Interactive sessions with fictional celebrities may provide for opportunities to create background sets that render the interactive session more impressive to the guest. For example, an interactive session with Sleeping Beauty™ may involve a virtual (e.g., electronically generated and superimposed on a blank screen) or real castle background. As mentioned, the background sets may include clickable merchandise items available for purchase by the guest.

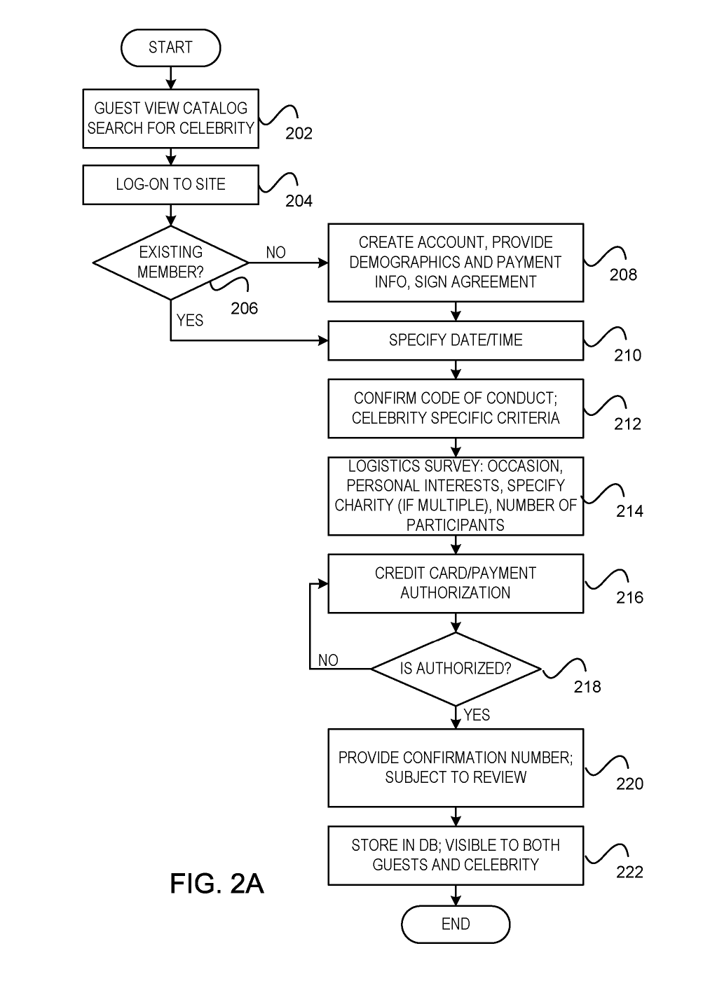

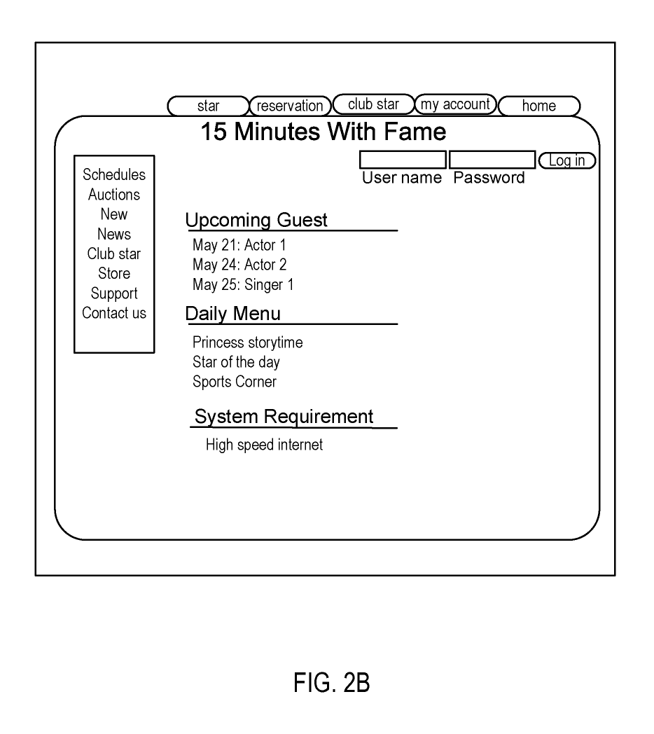

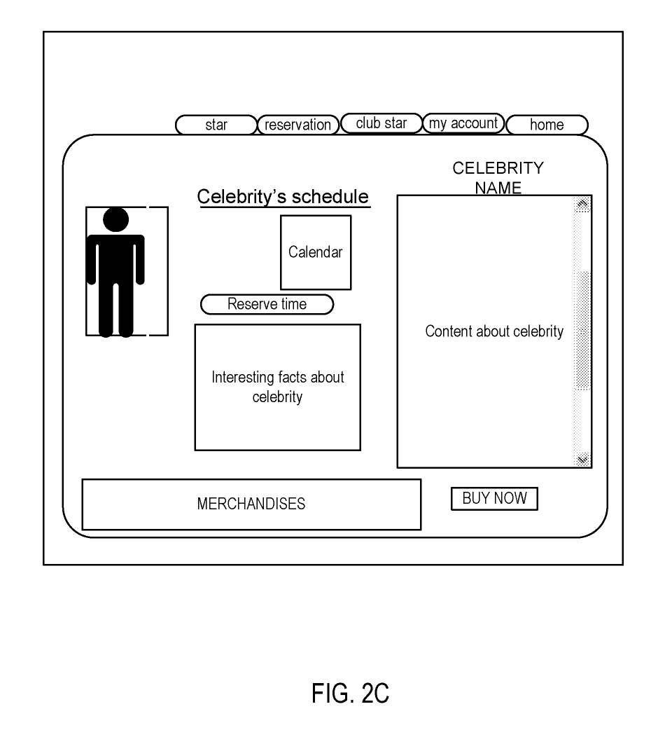

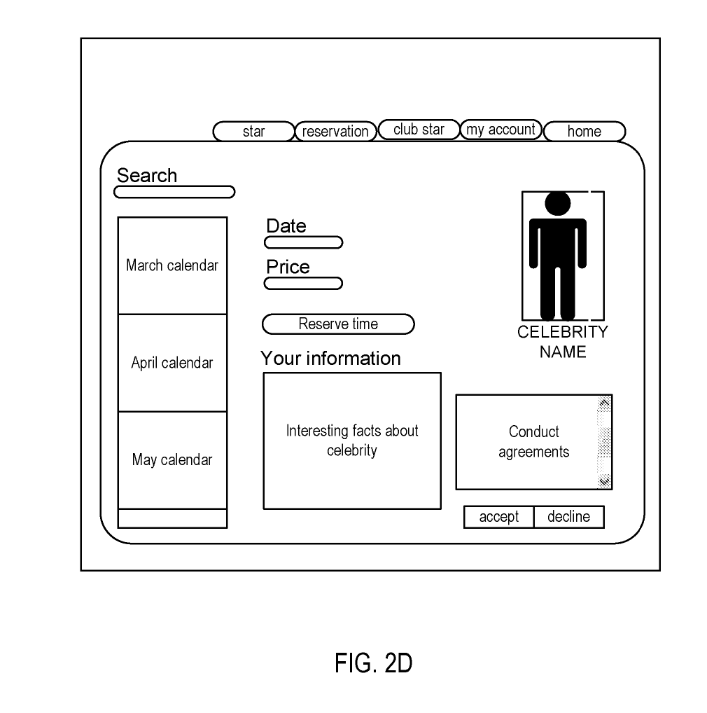

FIG. 2A depicts, in an embodiment of the invention, a simplified flowchart illustrating a sample reservation portion of the computer-implemented process. At step 202, the guest may access the website using an appropriate URL and view the online catalogue (i.e., database) to select or search for a specific celebrity. FIG. 2B shows an example of a screen that the guest may see upon accessing the website. Even during this initial stage, it is preferable that the charitable aspect of the CGROCIs conducted via the website be made clear to the guest. However, in an embodiment, the charitable aspect of the CGROCIs may be optional when a guest may wish to make a reservation for interaction with fictional characters.

The guest may perform a search using a variety of methods. For example, the guest may search the catalogue by typing in the celebrity name as the key word. If the guest does not know or remember the celebrity's name, the guest may type in the name of the character(s) that the celebrity may have portrayed. The guest may also search for a celebrity by a product that is associated with the celebrity or by the name of an organization or an event that the celebrity has been associated with. See FIG. 2C for an example of a screen providing data about the celebrity. Other search criteria may well be employed.

Once the guest has located a celebrity that he may want to reserve an interaction session with, the guest may log-on to the website (step 204). At step 206, if the guest is not a member of the website, the guest may be required to first register or create a user account (step 208). In creating a user account, the guest may be asked to provide personal data such as name, address, phone, and email address. Additionally, the guest may be asked to provide payment information such as a valid credit card. The IP address may also be noted, if desired. Before the user account may be created, the guest may be required to review and electronically sign a user agreement.

Once the guest has created a user account, the guest may be able to reserve the date and time with a chosen celebrity (step 210). A sample reservation screen is shown in FIG. 2D. During this reservation process, an automatic filter may be executed to screen the guest against a list of known troublemakers, which may be maintained by the website. Note that if at step 206 the guest already has a user account, then the guest may proceed directly to step 210. Giving the guest the ability to select the celebrity and the time slot provides great flexibility to guests. As can be seen herein, the reservation is subject to approval by the celebrity and/or the website operator.

At step 212, the guest may review and electronically sign a code of conduct. The code of conduct may include provisions similar to those in the previously signed user agreement. Further, the code of conduct may contain conditions, guidelines, or stipulations that may be specific to the celebrity with whom a guest wishes to have an interactive session. For example, the code of conduct that is specified for a given actress may require that the guest does not ask questions about the celebrity's previous five divorces during the interactive session.

At step 214, the guest may be provided an opportunity to answer a logistic survey that may request additional information, which may help the website and the celebrity to personalize the interactive session to the guest. Data that the logistic survey may ask the guest to provide may include, but are not limited to, description of the occasion, personal interests, hobbies, the number of participants anticipated, and the like.

The reservation details may then be presented on an invoice screen. The guest may be requested to review the invoice and confirm the method of payments (e.g., credit card and/or wire transfer). Note that payment is preferably obtained before the interactive session in order to obtain leverage on the guest's behavior during the interactive session (via the threat of not refunding the fee due to for cause termination, for example). Obtaining the payment in advance also greatly simplifies accounting by eliminating the collection process after the session has ended.

When the guest is ready, the guest is asked to authorize the payment (step 216). In some cases, payment made by non-credit card methods may require the assistance of a human operator. For example, the guest may have just made a winning bid worth $50,000 and may wish to pay with a wire transfer instead of with a credit card. In this case, a human operator may be summoned via the website to assist in the wire transfer.

At step 218, the charge/transfer is verified. For example, if the guest is paying by a credit card, a third party may have to approve the credit payment before the transaction is completed. If the payment is approved, then, at step 220, the guest may be provided with a confirmation number or some other mechanism to confirm the reservation. Further, the guest may be informed that all reservations are subject to review by the celebrity and/or the website operator. This review may be an additional filter in addition to the filter that takes place automatically when the guest selects a celebrity to begin the reservation process. At step 222, the information is stored on a database, which is accessible to the guest, celebrity and the host. Further, an email may be sent to both the guest and the celebrity detailing the upcoming session.

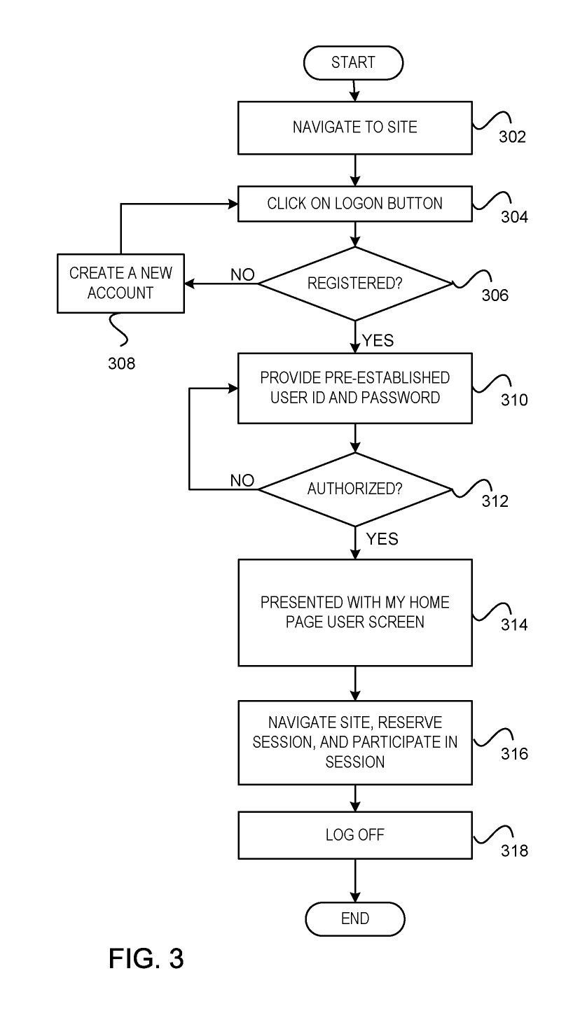

FIG. 3 shows, in an embodiment, a simplified flow chart of a login process from a guest perspective. At step 302, the guest navigates to the website and clicks on a logon button (step 304). Even at the homepage, the guest may be informed of the charity aspect of participating in a fee-based CGROCI. In an embodiment, the guest may not be informed about the charity aspect of participating in a fee-based CGROCI, since the charity aspect may be unavailable for interactive session with a fictional character. If the guest is not a registered member (step 306), the guest is directed to a new user screen, which allows the guest to register and/or create a new account (308). For example, the guest has received an interactive session with his favorite celebrity as a birthday present. Since the guest has never been on the website, the guest may have to register with the website before the guest is provided access to the website.

As mentioned in step 208 of FIG. 2, the guest may be asked to provide personal information, provide payment information, review and sign the user agreement. Once the guest has completed the registration, then the guest is directed back to the log-on page at step 304 to log in and use the website. However, if the guest is already a registered member (step 306) then the guest may provide, at step 310, his user id and password to access the site.

If the guest provided an incorrect user id or password, then access is not authorized (step 312) and the guest is directed back to step 310 to re-enter the password/id. However, if the guest is authorized to enter the website, then the guest is directed to a guest specific home page (step 314). On the guest specific home page, the guest may be able to update personal information, for example. Also, the guest may be shown a schedule of any upcoming session that the guest may have reserved or may have received as a gift. Further, the guest may be provided information about celebrities that have been recently added to the database or may be of interest to the guest based on his past sessions. Additionally, the guest may be provided with updated news about celebrities. In an embodiment, the guest may be able to customize the news that he may see.

At step 316, the guest may navigate the site to, for example, participate in a pre-arranged session. At step 318, the guest may log-off the site if the guest has completed navigating the site or has completed the interactive session with the celebrity. In an embodiment, the log-on session may be terminated by the website host if the user account is inactive for a pre-defined period of time.

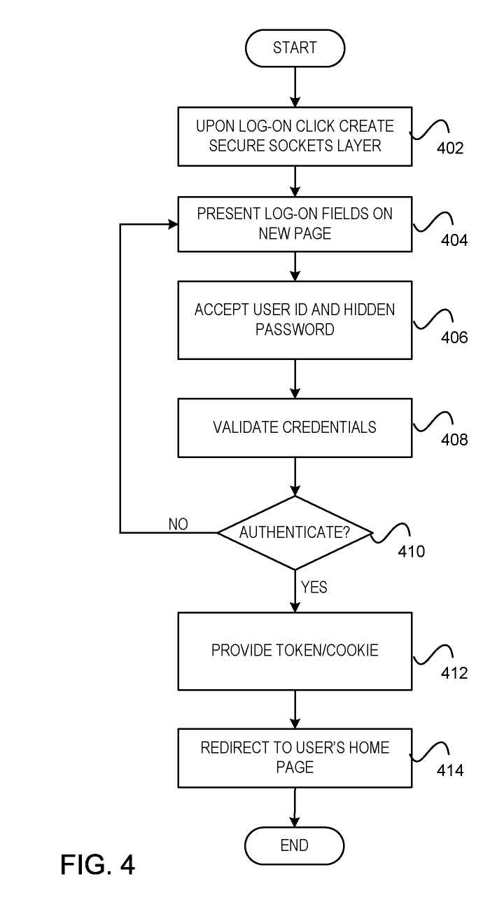

FIG. 4 shows, in an embodiment, a simplified flow chart of the log-on process from the system perspective. At step 402, a registered guest navigates to the site and clicks on a log-on button. Upon receiving the log-on click, the computer system creates a secure sockets layer (SSL). The computer system, at step 404, provides the guest with a screen wherein the guest may enter his log-on information. This log-on screen is, in an embodiment, a new secure shell. Once the log-on information (e.g. user id and password) have been entered, the computer system, at step 406, accepts the user id and hides the password.

The computer system at step 408 compares the log-on information entered against the log-on data stored on the database. If the log-on information fails to match the log-on data stored in the database (410), the computer system may redirect the guest back to step 404. However, if at step 410, the log-on data matches those in the database then, at step 412, the computer system provides for example a cookie or some other indication to the guest browser indicating that the session is valid. Once a cookie has been provided to the guest browser, the guest online session proceeds within a secure socket layer. Further, the cookie that may be provided may include a time duration, which may terminate the session if the guest is inactive for a certain period of time. At step 414, the computer system directs the guest to a personalized home page, which enables the guest to browse the website or to participate in an interactive session.

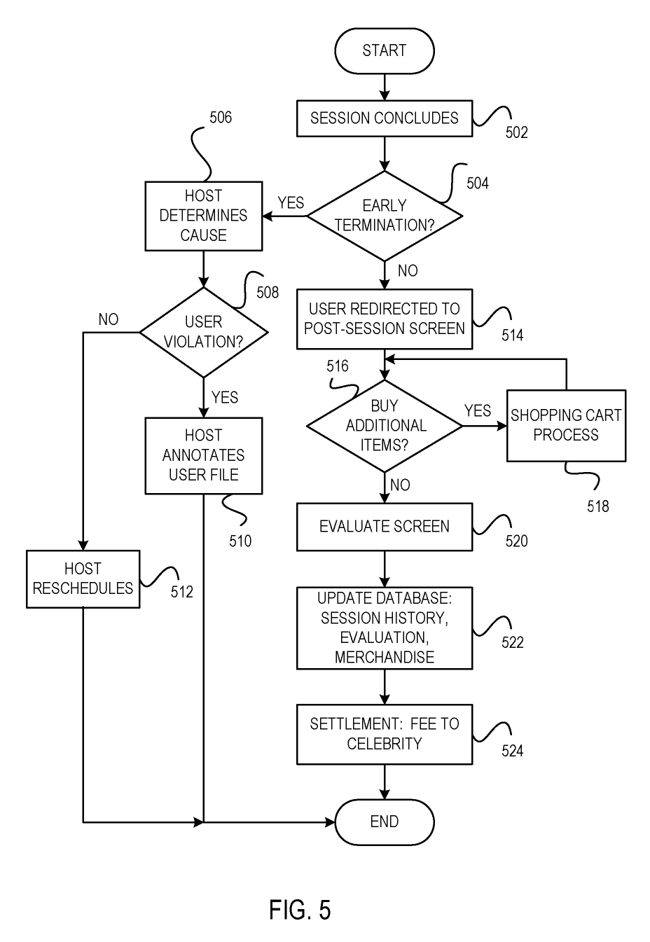

FIG. 5 shows, in an embodiment of the invention, a simplified flow chart of the post session process. At step 502 the actual interactive session with the celebrity has concluded. If the termination is an early termination (step 504) then at step 506, the website host may determine the cause of the early termination. If the website host determines at step 508 that the early termination is for cause, e.g., due to a user violation, then, at step 510, the website host may annotate the guest file to indicate the reason and may revoke the guest user agreement. Further, an early termination due to a user violation may result in the guest not being given a refund. This action is taken to discourage guests from violating the user agreement and/or any guidelines governing the session with the celebrity. If, at step 508, the website host determines that the early termination may not have been due to a user violation but may have been caused by factors outside the guest's control (e.g., a bad connection), the website host may offer the guest an opportunity to reschedule or the website host may provide the guest with a refund (512).

If the termination is not an early termination (as ascertained in step 504), then at step 514, the guest may be redirected to a post-session screen which may allow the guest to purchase items commemorating the session, such as an autographed book or note from the celebrity and/or a recording of the session and/or the guest may be offered an opportunity to purchase other related items. If the guest selects merchandise items for purchase during the session (step 516), the items selected may be processed to finalize the payment (step 518), and the guest may continue the loop from step 516 to 518 if the guest wishes to purchase additional items until the guest is satisfied.

Once the guest has completed the purchasing process, the guest is directed to an evaluation screen (step 520) wherein the guest may be provided an opportunity to provide feedback pertaining to the session. In an embodiment, the celebrity may also be furnished with a feedback screen to provide feedback about the guest. Feedback may include, but is not limited to, the guest's perception of the interaction experience, the celebrity's perception of the interaction experience, and/or any technical issues.

At step 522, the database may be updated with the feedback. Further, the database may be updated with history information about the session such as data pertaining to the items purchased, the identity of the participants, the time of the session, and/or any other notes or evaluations made. The database may be able to provide the host with reports that may help the host improve the website.

At step 524, money settlement occurs. In an embodiment, the celebrity is credited with the entire proceeds amount collected from the guest, minus any administrative fees charged by the website operator for providing the facility to conduct the CGROCI. The celebrity is then free to decide the percentage of compensation to allocate to the charity or charities. In another embodiment, the celebrity may be provided only with the amount due to the celebrity, with the website operator withholding an amount that includes the administrative fees to the website and any amount the celebrity has specified as being allocated to the charity. The website may then forward the allocated portion of the session proceeds to the charity specified.

As can be appreciated from the foregoing, there are several advantages provided by embodiments of the present invention. Firstly, the for-pay online interactive session is conducted with an understanding that a portion of the proceeds will benefit a charitable cause. Since the invention's apparatus and method informs the guest of this fact up front, the charity aspect substantially removes the taint of self-interest from possibly degrading the celebrity's image and/or reputation.

Further, embodiments of the invention provide a safe and secure online environment where celebrities can post available time slots and guests can reserve time slots with their favorite celebrities. Since the reservation is subject to screening and/or approval by the celebrity, the celebrity is given a significant degree of control over the people chosen for the online interaction. Further, since guests can control the selection process (e.g., selection of the celebrity to meet from a list of available celebrities, selection of the date and time that the proposed interaction may take place, etc.) embodiments of the invention render it substantially easier and more user-friendly for guests to arrange for a session with celebrities.

The on-line nature of the interaction also substantially eliminates the possibility of physical harm to the celebrities during the session, as well as substantially reduces the cost and time involved with conducting a face-to-face in-person meeting, even if the celebrity and the guest live in different continents.

During the session, the presence of merchandise items that are clickable for purchase, in the background setting and/or in a dedicated area of the frame, renders it highly likely that the guest will purchase at least an item or two before terminating the session. These and other advantages mentioned throughout this disclosure enable celebrities to satisfy the public demand for more personal interactions while enabling the celebrities and/or the charity to obtain revenue and/or increase revenue from the online guest-reservable interactions in a dignified, reputation-enhancing manner, while suffering none of the advantages associated with prior art methods.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention. In the following claims, the terms “first”, “second”, “third”, “fourth”, “fifth”, and other sequential terminology are employed for labeling purposes to improve clarity of understanding and do not necessarily imply or define a chronological sequence or a logical sequence.

What is claimed is:

1. A computer-implemented method for facilitating a charitable guest reservable online celebrity interaction (CGROCI) between a guest and a celebrity via a computer-network, comprising:
providing said guest with information informing said guest of a charitable nature of said CGROCI, said charitable nature relating to a financial benefit provided to a charity as a result of conducting said CGROCI;
receiving via said computer-network reservation data from said guest, said reservation data specific at least a time to conduct said CGROCI;
providing an online interactive environment to conduct said CGROCI between said guest and said celebrity, whereby said celebrity is geographically remote from said guest but interacting with said guest via said online interactive environment; and
processing payment from said guest for said CGROCI, whereby at least a first portion of said payment is provided to said charity and a second portion of said payment is provided to said celebrity.

2. The method of claim 1 wherein said charity represents a guest-selected charity among a plurality of charities presented for selection by said guest.

3. The method of claim 1 wherein said celebrity is human.

4. The method of claim 1 wherein said celebrity is a fictional character.

5. The method of claim 1 wherein said celebrity represents a guest-selected celebrity among a plurality of celebrities presented for selection by said guest.

6. The method of claim 1 further comprising providing said guest with a conduct agreement for electronic signing by said guest, whereby violation of said conduct agreement is ground for early termination of said CGROCI.

7. The method of claim 6 wherein said conduct agreement provides said guest with a list of issues not available for discussion during said CGROCI.

8. The method of claim 1 further comprising receiving personal customization data from said guest.

9. A system for facilitating a charitable guest reservable online celebrity interaction (CGROCI) between a guest and a celebrity via a computer-network, wherein providing said guest with information informing said guest of a charitable nature of said CGROCI, said charitable nature relating to a financial benefit provided to a charity as a result of conducting said CGROCI, comprising:
mean for receiving via said computer-network reservation data from said guest, said reservation data specific at least a time to conduct said CGROCI;
mean for providing an online interactive environment to conduct said CGROCI between said guest and said celebrity, whereby said celebrity is geographically remote from said guest but interacting with said guest via said online interactive environment; and
mean for processing payment from said guest for said CGROCI, whereby at least a first portion of said payment is provided to said charity and a second portion of said payment is provided to said celebrity.

10. The system of claim 9 wherein said charity represents a guest-selected charity among a plurality of charities presented for selection by said guest.

11. The system of claim 9 wherein said celebrity is human.

12. The system of claim 9 wherein said celebrity is a fictional character.

13. The system of claim 9 wherein said celebrity represents a guest-selected celebrity among a plurality of celebrities presented for selection by said guest.

14. The system of claim 9 further comprising a mean for providing said guest with a conduct agreement for electronic signing by said guest, whereby violation of said conduct agreement is ground for early termination of said CGROCI.

15. The system of claim 14 wherein said conduct agreement provides said guest with a list of issues not available for discussion during said CGROCI.

16. The system of claim 9 further comprising a mean for receiving personal customization data from said guest.

17. A computer-implemented method for facilitating a charitable guest reservable online celebrity interaction (CGROCI) among a plurality of simultaneous instantiations of a celebrity by a plurality of human actors and at least a first guest and a second guest via a computer-network, said celebrity representing a fictional character enacted by human, comprising:
providing said first guest and said second guest with information informing said first guest and said second guest of a charitable nature of said CGROCI, said charitable nature relating to a financial benefit provided to a charity as a result of conducting said CGROCI;
receiving via said computer-network reservation data from said first guest and said second guest, said reservation data specific at least time appointments to conduct said CGROCI;
providing an online interactive environment to conduct said CGROCI among said first guest and said second guest and said plurality of simultaneous instantiations, whereby said plurality of human actors are geographically remote from said first guest and said second guest but interacting with said first guest and said second guest via said online interactive environment; and
processing payment from said first guest and said second guest for said CGROCI, whereby at least a first portion of said payment is provided to said charity and a second portion of said payment is provided to an owner of a right to said celebrity.

18. The method of claim 17 wherein said charity represents a guest-selected charity among a plurality of charities presented for selection by said first guest and said second guest.

19. The method of claim 17 wherein said celebrity represents a guest-selected celebrity among a plurality of celebrities presented for selection by said first guest and said second guest.

20. The method of claim 17 further comprising providing said first guest and said second guest with a conduct agreement for electronic signing by said first guest and said second guest, whereby violation of said conduct agreement is ground for early termination of said CGROCI.

21. The method of claim 20 wherein said conduct agreement provides said first guest and said second guest with a list of issues not available for discussion during said CGROCI.

22. The method of claim 17 further receiving personal customization data from said first guest and said second guest.
